(19) United States
(12) Patent Application Publication
(10) Pub. No.: US 2009/0099844 A1
(43) Pub. Date: Apr. 16, 2009

(54) EFFICIENT IMPLEMENTATION OF ANALYSIS AND SYNTHESIS FILTERBANKS FOR MPEG AAC AND MPEG AAC ELD ENCODERS/DECODERS

(75) Inventors: Yuriy Reznik, San Diego, CA (US); Ravi Kiran Chivukula, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/252,195

(22) Filed: Oct. 15, 2008

Related U.S. Application Data
(60) Provisional application No. 60/980,418, filed on Oct. 16, 2007.

(51) Int. Cl. G10L 19/00

(52) U.S. Cl. 704/220; 704/E19.001

(57) ABSTRACT

An encoder may include a core MDCT filterbank that can be used to implement an advanced audio coding (AAC) algorithm, an AAC-enhanced low delay (ELD) algorithm or both algorithms. For the AAC algorithm, a sequence of input samples is sent directly to the MDCT filterbank to obtain a sequence of output samples. For the AAC-ELD algorithm, the signs of input samples of the sequence of input samples are inverted, the MDCT analysis filterbank is applied to the sign-inverted sequence of input samples to obtain a sequence of output samples, the order of the sequence of output samples is reversed, and the signs of alternating output samples of the sequence of output samples are inverted. Similarly, a decoder may include a core IMDCT synthesis filterbank that can be used to implement AAC-ELD or both AAC and AAC-ELD algorithms. The steps for the decoder are merely the reverse of the encoder.

### CLAIM OF PRIORITY UNDER 35 U.S.C. §119

The present Application for Patent claims priority to U.S. Provisional Application No. 60/980,418, entitled “Efficient Joint Implementation of analysis and Synthesis Filterbanks For MPEG AAC and MPEG AAC ELD Encoders/Decoders” filed Oct. 16, 2007, and assigned to the assignee hereof and hereby expressly incorporated by reference herein.

### BACKGROUND

1. Field

The following description generally relates to encoders and decoders and, in particular, to filterbank implementations for Advanced Audio Coding (AAC) and AAC Enhanced Low Delay (ELD).

2. Background

One goal of audio coding is to compress an audio signal into a desired limited information quantity while keeping as much as the original sound quality as possible. In an encoding process, an audio signal in a time domain is transformed into a frequency domain.

Advanced Audio Coding (AAC) is a standardized, lossy compression and encoding scheme for digital audio that is specified as part of the Movie Pictures Expert Group (MPEG) standard. AAC is a wideband audio coding algorithm that exploits two primary coding strategies to dramatically reduce the amount of data needed to represent high-quality digital audio. First, signal components that are perceptually irrelevant are discarded. Second, redundancies in the coded audio signal are eliminated. In order to apply these techniques the signal is first processed by a modified discrete cosine transform (MDCT). The modified discrete cosine transform (MDCT) is a Fourier-related transform based on the type-IV discrete cosine transform (DCT-IV), with the additional property of being lapped. The relation of MDCT transform to DCT-IV and Fourier transforms allows such filterbanks to be very efficiently implemented by using so-called “fast” algorithms (related to Fast Fourier Transform (FFT) algorithm—see K. R. Rao, and P. Yip, “Discrete Cosine Transform: Algorithms, Advantages, Applications”, Academic Press, 1990 ISBN: 012580203X ).

An emerging MPEG AAC-ELD (Enhanced Low-Delay) codec is designed to combine the advantages of perceptual audio coding with the low delay necessary for two-way communication. However, AAC-ELD uses a different filterbank structure as compared to the traditional AAC codec. This filterbank is not compatible with MDCT or DCT-IV transforms and can not be directly computed by existing fast algorithms. This increases the complexity and cost of implementing AAC-ELD. This also increases complexity and cost when both types of algorithms are to be implemented on the same DSP core. Therefore, there is a need for a simpler way to implement AAC-ELD or both AAC and AAC-ELD codec algorithms on the same DSP core.

### SUMMARY

The following presents a simplified summary of one or more embodiments in order to provide a basic understanding of some embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

An encoder is provided that includes a core MDCT analysis filterbank that can be used to implement an advanced audio coding (AAC) algorithm, an AAC-enhanced low delay (ELD) algorithm or both algorithms. For the AAC algorithm, input samples are sent directly to the MDCT analysis filterbank to obtain output samples. For the AAC-ELD algorithm, the signs of the signs of a first set of input samples are inverted, the MDCT analysis filterbank is applied to obtain spectral coefficient output samples, the order of the spectral coefficient output samples are reversed, and the signs of a second set of alternating spectral coefficient output samples are inverted.

According to one example, an encoder is provided that implements an analysis filterbank using a common core modified discrete cosine transform. A sequence of input samples is obtained and the signs of a first set of alternating input samples are inverted. Spectral coefficient output samples are generated by applying a modified discrete cosine transform (MDCT) to the sequence of input samples. The order the spectral coefficient output samples is reversed and the signs a second set of alternating spectral coefficient output samples are then inverted. In one example, the sequence of input samples is N samples long, and inverting the signs of the first set of alternating input samples includes: (a) inverting the signs of the even-indexed input samples of the sequence if N/4 is an even number; and (b) inverting the signs of the odd-indexed input samples of the sequence if N/4 is an odd number. In another example, the sequence of input samples is N samples long, and inverting the signs of the second set of alternating spectral coefficient output samples includes: (a) inverting the signs of the odd-indexed spectral coefficient output samples if N/2 is an even number; and (b) inverting the signs of the even-indexed spectral coefficient output samples if N/2 is an odd number. In one mode of operation, the MDCT may operate as an advanced audio coding (AAC) filterbank. In another mode of operation, the analysis filterbank may operate as an AAC enhanced low-delay (ELD) filterbank.

Similarly, a decoder is provided that implements a synthesis filterbank using a common core inverse modified discrete cosine transform. A sequence of input spectral coefficients is obtained and the signs of a first set of alternating spectral coefficients are inverted. The order of the input spectral coefficients is reversed. Output samples are generated by applying an inverse modified discrete cosine transform (IMDCT) to the spectral coefficients. The signs of a second set of alternating output samples are then inverted.

In one example, the sequence of input spectral coefficients is N samples long, and inverting the signs of the first set of alternating input spectral coefficients includes: (a) inverting the signs of the odd-indexed spectral coefficients if N/2 is an even number; and (b) inverting the signs of the even-indexed spectral coefficients if N/2 is an odd number.

In another example, the sequence of input spectral coefficients is N samples long, and inverting the signs of the second set of alternating output samples includes: (a) inverting the signs of the odd-indexed output samples if N/4 is an odd number; and (b) inverting the signs of the even-indexed output samples if N/4 is an even number. In one mode of operation, the IMDCT may operate as an advanced audio coding (AAC) filterbank. In another mode of operation, the synthesis filterbank may operate as an AAC enhanced low-delay (ELD) filterbank.

### BRIEF DESCRIPTION OF THE DRAWINGS

Various features, nature, and advantages may become apparent from the detailed description set forth below when taken in conjunction with the drawings in which like reference characters identify correspondingly throughout.

FIG. 1 is a block diagram illustrating an example of an encoder which may implement AAC-ELD or both MPEG AAC and AAC-ELD in the same MDCT analysis filterbank structure.

FIG. 2 is a block diagram illustrating an example of a decoder which may implement both AAC-ELD or MPEG AAC and AAC-ELD in the same IMDCT filterbank structure.

FIG. 3 is a block diagram illustrating an AAC analysis filterbank that may be utilized by an encoder.

FIG. 4 is a diagram illustrating the operations that are performed to reuse the core MDCT of FIG. 3 for an AAC-ELD algorithm.

FIG. 5 illustrates a method of performing AAC-ELD algorithm using a core MDCT for an AAC algorithm.

FIG. 6 is a block diagram illustrating a device, circuit, and/or processor adapted to reuse an AAC algorithm MDCT for an AAC-ELD algorithm.

FIG. 7 is a block diagram illustrating an AAC synthesis filterbank that may be utilized by a decoder.

FIG. 8 is a diagram illustrating the operations that are performed to reuse the core IMDCT of FIG. 7 for an AAC-ELD algorithm.

FIG. 9 illustrates a method of performing AAC-ELD algorithm using a core IMDCT for an AAC algorithm.

FIG. 10 is a block diagram illustrating a device, circuit, and/or processor adapted to reuse an AAC algorithm IMDCT for an AAC-ELD algorithm.

### DETAILED DESCRIPTION

Various embodiments are now described with reference to the drawings, wherein like reference numerals are used to refer to like elements throughout. In the following description, for purposes of explanation, numerous specific details arc set forth in order to provide a thorough understanding of one or more embodiments. It may be evident, however, that such embodiment(s) may be practiced without these specific details. In other instances, well-known structures and devices are shown in block diagram form in order to facilitate describing one or more embodiments.

### Overview

One feature provides a way to implement AAC-ELD or both AAC and AAC-ELD algorithms using the same core MDCT analysis filterbank and core IMDCT synthesis filterbank.

An encoder may include a core MDCT analysis filterbank that can be used to implement AAC-ELD or both AAC and AAC-ELD algorithms. For the AAC algorithm, input samples are sent directly to the MDCT analysis filterbank to obtain output samples. For the AAC-ELD algorithm, a vector of residual values of input samples is formed and the signs of a first set of alternating input samples are inverted. Spectral coefficient output samples are generated by applying a modified discrete cosine transform (MDCT) to the sequence of input samples. The order of the spectral coefficient output samples is then reversed and the signs a second set of alternating spectral coefficient output samples are inverted.

Similarly, a decoder may include a core IMDCT synthesis filterbank that can be used to implement AAC-ELD or both AAC and AAC-ELD algorithms. For the AAC algorithm, input samples are sent directly to the IMDCT synthesis filterbank to obtain output samples. For the AAC-ELD algorithm, a sequence of input spectral coefficients is obtained and the signs of a first set of alternating spectral coefficients are inverted. The order of the input spectral coefficients is reversed. Output samples are generated by applying an inverse modified discrete cosine transform (IMDCT) to the spectral coefficients. The signs of a second set of alternating output samples are then inverted.

Because both AAC and AAC-ELD filterbanks may be implemented using the same MDCT and IMDCT core modules, this allows reusability of existing code with only a few minor modifications. If only an AAC-ELD filterbank is to be implemented, the disclosed methods offer a simple solution utilizing known fast MDCT filterbanks implementations.

### Codec Structure

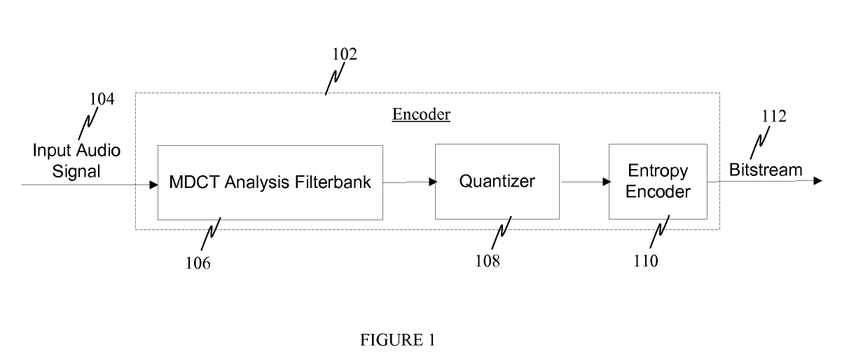

FIG. 1 is a block diagram illustrating an example of an encoder which may implement AAC-ELD or both MPEG AAC and AAC-ELD in the same MDCT analysis filterbank structure. The encoder 102 may receive an input audio signal 104. An MDCT Analysis Filterbank 106 (i.e., modified discrete cosine transform based on the type-IV discrete cosine transform) operates to decompose the time-domain input audio signal 104 into a plurality of sub-band signals and convert the signals to the frequency-domain, where each sub-band signal is converted into a transform coefficient per sub-band per block. The resulting signal is then quantized by a Quantizer 108 and encoded by an Entropy Encoder 110 to produce a bitstream 112 of the digitized audio signal.

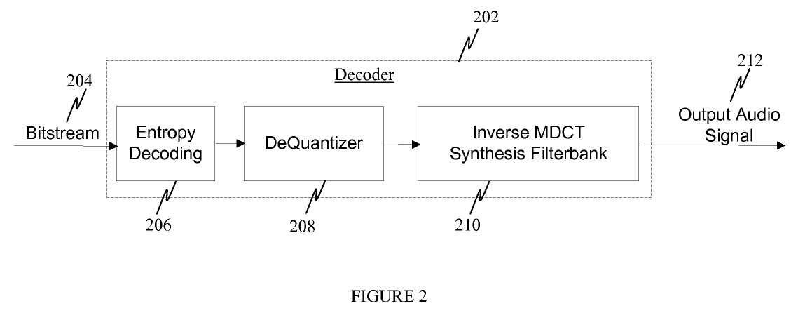

FIG. 2 is a block diagram illustrating an example of a decoder which may implement AAC-ELD or both MPEG AAC and AAC-ELD in the same IMDCT filterbank structure. The decoder 202 may receive a bitstream 204. An Entropy Decoder 206 decodes the bitstream 204 which is then dequantized by a Dequantizer 208 to produce a frequency-domain signal. An IMDCT Synthesis Filterbank 210 (i.e., inverse modified discrete cosine transform based on the type-IV discrete cosine transform) operates to convert the frequency-domain signal 104 back to a time-domain audio signal 212.

### AAC-ELD

The AAC ELD core coder analysis (Equation 1) and synthesis (Equation 2) filterbanks can be defined as follows:

$$\begin{matrix}X ( k ) = - 2 {\sum }_{n = - N}^{N - 1} z ( n ) cos ( \frac{2 π}{N} ( n + {n}_{0} ) ( k + \frac{1}{2} ) ) , \\ for 0 \leq k \leq \frac{N}{2} , & ( Equation 1 ) \\ x ( n ) = - \frac{2}{N} {\sum }_{k = 0}^{\frac{N}{2} - 1} X ( k ) cos ( \frac{2 π}{N} ( n + {n}_{0} ) ( k + \frac{1}{2} ) ) , \\ for 0 \leq n \leq 2 N , & ( Equation 2 )\end{matrix}$$

where

$${n}_{0} = ( \frac{N / 2 + 1}{2} ) ,$$

z(n) denotes windowed input data samples, X(k) denotes subband coefficients, x(n) denotes reconstructed samples (prior to aliasing cancellation). In one example, N may be 1024 or 960.

### MDCT and IMDCT

The Modified Discrete Cosine Transform (MDCT) (Equation 3) and the Inverse MDCT (IMDCT) (Equation 4) are usually defined as follows:

$$\begin{matrix}\tilde{X} ( k ) = 2 {\sum }_{n = 0}^{N - 1} z ( n ) cos ( \frac{2 π}{N} ( n + {p}_{0} ) ( k + \frac{1}{2} ) ) , \\ k = 0 , 1 , … , N / 2 - 1 , & ( Equation 3 ) \\ \tilde{x} ( n ) = \frac{2}{N} {\sum }_{k = 0}^{N / 2 - 1} \tilde{X} ( k ) cos ( \frac{2 π}{N} ( n + {p}_{0} ) ( k + \frac{1}{2} ) ) , \\ n = 0 , 1 , … , N - 1 , & ( Equation 4 )\end{matrix}$$

where

$${p}_{0} = ( \frac{N / 2 + 1}{2} ) ,$$

and where z(n) denotes windowed input data samples, \tilde{X}(k) denotes MDCT spectral coefficients, and \tilde{x}(n) denotes reconstructed samples (prior to aliasing cancellation).

### Encoder: AAC and AAC-ELD Analysis Filterbank

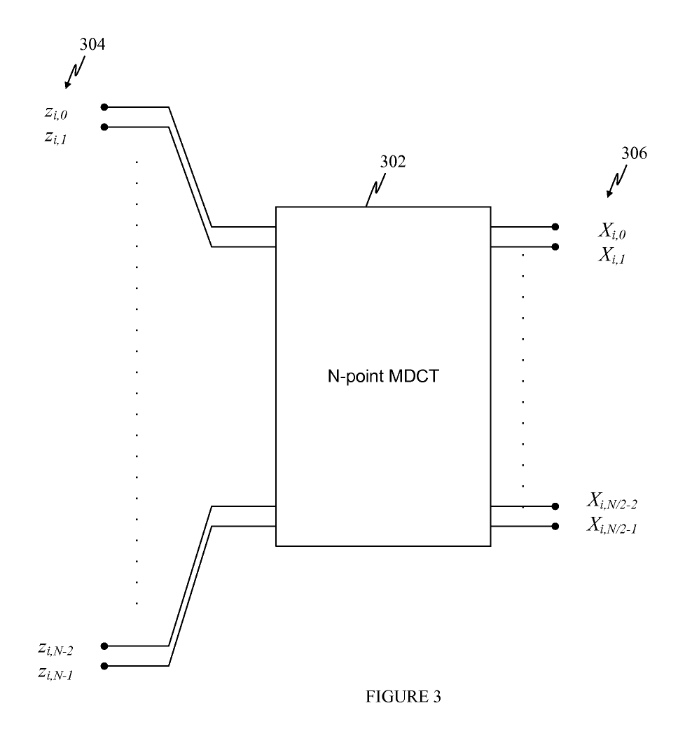

FIG. 3 is a block diagram illustrating an AAC analysis filterbank that may be utilized by an encoder. The analysis filterbank in AAC is simply an MDCT filterbank 302 that receives input samples z_{i,0} to z_{i,N-1} 304 and generates output spectral coefficients X_{i,0} to X_{i,N/2-1} 306, which can be represented by:

$${X}_{i , k} = 2 \cdot {\sum }_{n = 0}^{N - 1} {z}_{i , n} cos ( \frac{2 π}{N} ( n + {p}_{0} ) ( k + \frac{1}{2} ) ) , 0 \leq k < \frac{N}{2}$$

where:

z_{i,n}=windowed input sequence

X_{i,k}=output spectral coefficients

n=sample index

k=spectral coefficient index

i=block index

N=window length based on the window_sequence value

p₀=(N/2+1)/2.

The analysis filterbank in AAC-ELD output X_{i,k} can be represented by:

$${X}_{i , k} = - 2 \cdot {\sum }_{n = - N}^{N - 1} {z}_{i , n} cos ( \frac{2 π}{N} ( n + {n}_{0} ) ( k + \frac{1}{2} ) )$$

$$for 0 \leq k < N / 2$$

where:

z_{i,n}=windowed input sequence

X_{i,k}=output spectral coefficients

n=sample index

K=spectral coefficient index

I=block index

N=window length based on the window_sequence value

n₀=(−N/2+1)/2.

In the case of an AAC-ELD analysis filterbank, for

$$0 \leq k < \frac{N}{2} ,$$

it can be shown that:

$$\begin{matrix}X ( k ) = - 2 {\sum }_{n = - N}^{- 1} z ( n ) cos ( \frac{2 π}{N} ( n + {n}_{0} ) ( k + \frac{1}{2} ) ) - \\ 2 {\sum }_{n = 0}^{N - 1} z ( n ) cos ( \frac{2 π}{N} ( n + {n}_{0} ) ( k + \frac{1}{2} ) ) ; \\ = - 2 {\sum }_{n = 0}^{N - 1} z ( n - N ) cos ( \frac{2 π}{N} ( n - N + {n}_{0} ) ( k + \frac{1}{2} ) ) - \\ 2 {\sum }_{n = 0}^{N - 1} z ( n ) cos ( \frac{2 π}{N} ( n + {n}_{0} ) ( k + \frac{1}{2} ) ) ; \\ = - 2 {\sum }_{n = 0}^{N - 1} ( z ( n ) - z ( n - N ) ) cos ( \frac{2 π}{N} ( n + {n}_{0} ) ( k + \frac{1}{2} ) ) ; \\ = - 2 {\sum }_{n = 0}^{N - 1} ( z ( n ) - z ( n - N ) ) cos ( \frac{2 π}{N} ( n + {p}_{0} - \frac{N}{2} ) ( k + \frac{1}{2} ) ) ; \\ = - 2 {( - 1 )}^{k} {\sum }_{n = 0}^{N - 1} ( z ( n ) - z ( n - N ) ) sin ( \frac{2 π}{N} ( n + {p}_{0} ) ( k + \frac{1}{2} ) ) . \\ \begin{matrix}X ( \frac{N}{2} - 1 - k ) = - 2 {( - 1 )}^{( \frac{N}{2} - 1 - k )} {\sum }_{n = 0}^{N - 1} ( z ( n ) - z ( n - N ) ) \\ sin ( \frac{2 π}{N} ( n + {p}_{0} ) ( \frac{N}{2} - 1 - k + \frac{1}{2} ) ) ; \\ = {( - 1 )}^{( \frac{N}{2} - 1 - k )} 2 {\sum }_{n = 0}^{N - 1} ( {( - 1 )}^{( n + \frac{N}{4} + 1 )} ( z ( n ) - z ( n - N ) ) ) \\ cos ( \frac{2 π}{N} ( n + {p}_{0} ) ( k + \frac{1}{2} ) )\end{matrix}\end{matrix}$$

which allows reuse of core MDCT filterbank for its implementation. Note that the right hand side of the summation is an MDCT (e.g., as in Equation 3). The algorithm for the analysis filterbank may include:
1. Form the sequence of input samples (z(n)−z(n−N)) for 0≦n<N;
2. Invert the signs of the even-indexed samples if N/4 is even or invert the signs of odd-indexed samples if N/4 is odd;
3. Apply the MDCT transform to the samples to obtain output samples (spectral coefficients);
4. Reverse the order of the output samples;
5. Invert the signs of the odd-indexed output samples if N/2 even, or invert the signs of the even-indexed output samples if N/2 is odd.

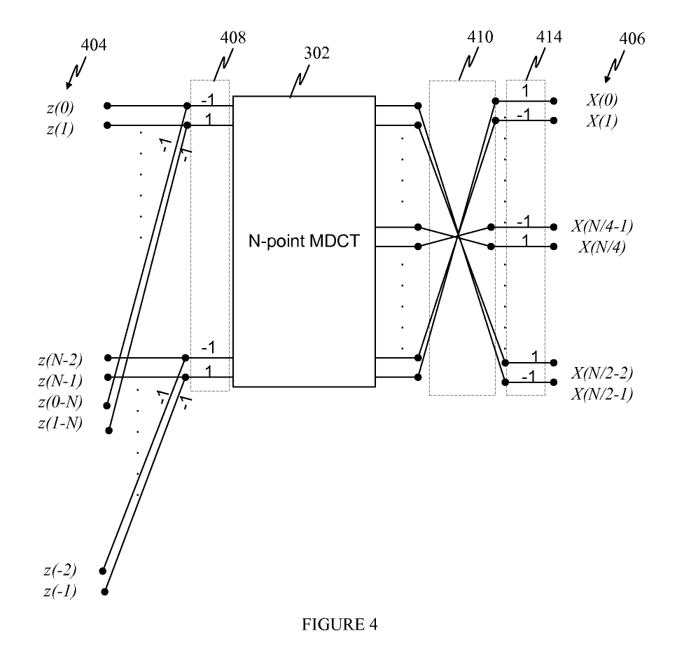

FIG. 4 is a diagram illustrating the operations that are performed to reuse the core MDCT of FIG. 3 for an AAC-ELD algorithm. This figure assumes that N/4 is an even number. To obtain the analysis filterbank output 406, a sequence of input samples 404 (e.g., [z_{i,n}−z_{i(n-N)}] for 0≦n<N) is formed. The signs of the even-indexed input samples of this sequence of input samples 404 are inverted 408. Note that if N/4 was an odd number, the signs of odd-indexed input samples are inverted instead. Then the MDCT 302 is applied to the sign-inverted sequence of input samples to obtain a sequence of output samples (spectral coefficients). Then the order of the sequence of output samples is reversed 410. Finally, the signs of odd-indexed output samples of the sequence of output samples are inverted 414. Note that if N/2 was an odd number, the signs of even-indexed output samples of the sequence of output samples are inverted instead. The functions and/or operations described in FIG. 4 may be performed in hardware, software, or a combination of the two.

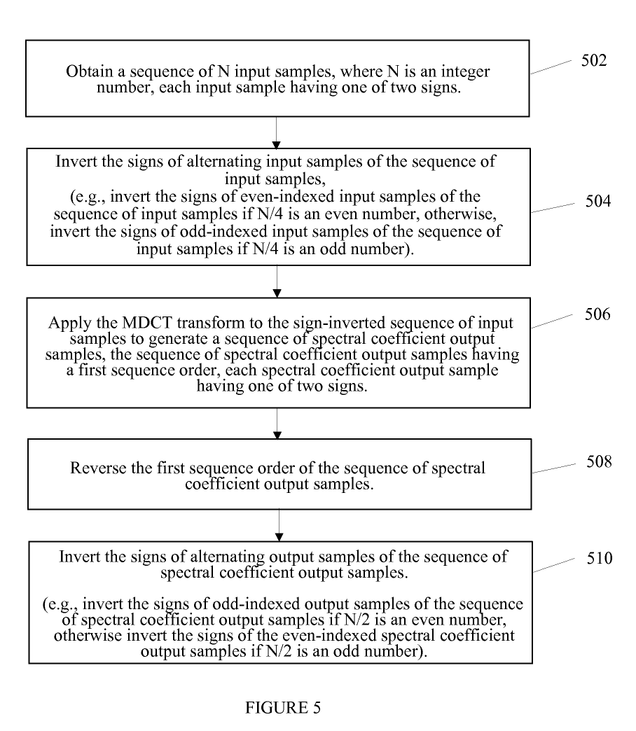

FIG. 5 illustrates a method of performing AAC-ELD algorithm using a core MDCT for an AAC algorithm. A sequence of N input samples is obtained, where N is an integer number, each input sample having one of two signs 502. Such sequence of N input samples may be a time-domain sampled audio signal. In some implementations, the sequence of input samples may be one of either N=960 or 1024 samples long. The signs of alternating input samples of the sequence of spectral coefficient input samples are then inverted 504. For example, if N/4 is an even number, the signs of even-indexed input samples of the sequence of input samples are inverted, otherwise if N/4 is an odd number, the signs of odd-indexed input samples of the sequence of input samples are inverted. An MDCT transform (for AAC) is then applied to the sign-inverted sequence of input samples to generate a sequence of spectral coefficient output samples, the sequence of spectral coefficient output samples having a first sequence order, each spectral coefficient output sample having one of two signs 506. The first sequence order of the sequence of spectral coefficient output samples is then reversed 508. The signs of alternating output samples of the sequence of spectral coefficient output samples are then inverted 510. For example, if N/2 is an even number, the signs of odd-indexed output samples of the sequence of spectral coefficient output samples are inverted, otherwise if N/2 is an odd number, the signs of even-indexed output samples of the sequence of spectral coefficient output samples are inverted.

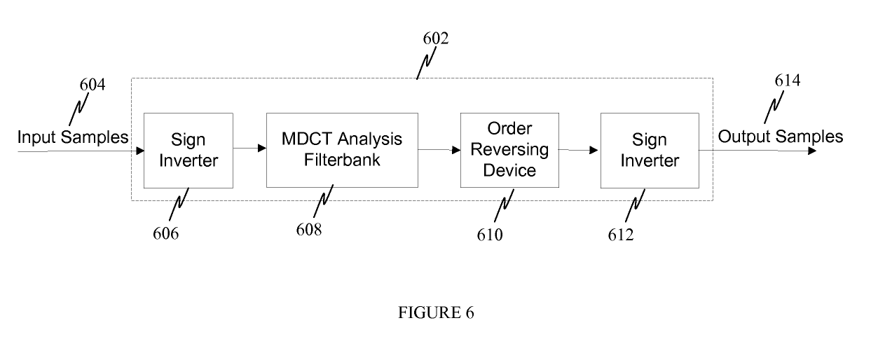

FIG. 6 is a block diagram illustrating a device, circuit, and/or processor adapted to reuse an AAC algorithm MDCT for an AAC-ELD algorithm. The device, circuit, and/or processor 602 may include a first Sign Inverter 606 to invert the signs of alternating input samples of a sequence of input samples 604. For instance, where the window length is N and if N/4 is an even number, the first Sign Inverter 606 may invert the signs of even-indexed input samples of the sequence of input samples 604. Alternatively, if N/4 is an odd number, the first Sign Inverter 606 may invert the signs of odd-indexed input samples of the sequence of input samples 604. An MDCT Analysis Filterbank 608 then applies an MDCT transform to the sign-inverted sequence of input samples to generate a sequence of spectral coefficient output samples (e.g., spectral coefficients). The sequence of spectral coefficient output samples may have a first sequence order, with each spectral coefficient output sample having one of two signs. An Order Reversing Device 610 then reverses the first sequence order of the sequence of spectral coefficient output samples (e.g., the sequence of the spectral coefficients is reversed). Then, a second Sign Inverter 612 inverts the signs of odd-indexed output samples of the sequence of spectral coefficient output samples if N/2 is even, or inverts the signs of even-indexed output samples of the sequence of spectral coefficient output samples if N/2 is odd, to provide sign-inverted and order-reversed Output Samples 614.

### Decoder: AAC and AAC-ELD Synthesis Filterbanks

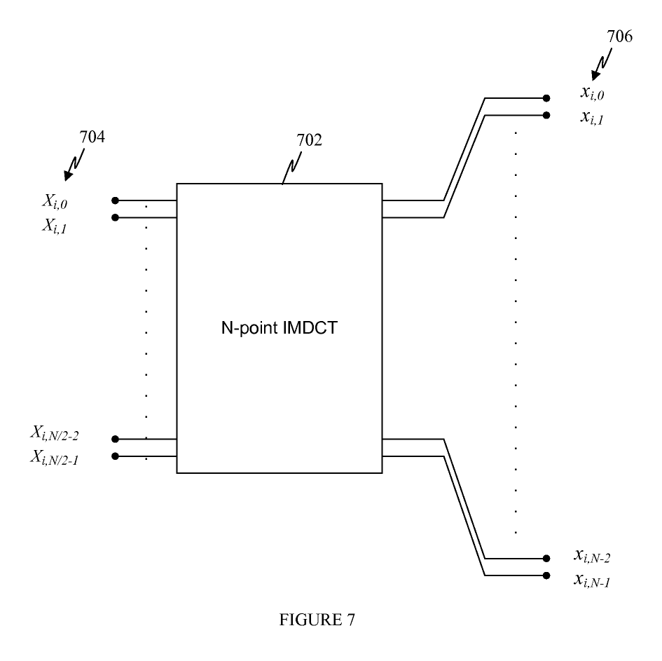

FIG. 7 is a block diagram illustrating an AAC synthesis filterbank that may be utilized by a decoder. The synthesis filterbank in AAC is simply an IMDCT filterbank 702 that receives input samples (e.g., spectral coefficients) spec[i][0] to spec[i][N/2−1] 704 and generates outputs (e.g., samples) x_{i,0} to x_{i,2N-1} 706, which can be represented by:

$${x}_{i , n} = \frac{2}{N} {\sum }_{k = 0}^{\frac{N}{2} - 1} {X}_{i , k} cos ( \frac{2 π}{N} ( n + {p}_{0} ) ( k + \frac{1}{2} ) )$$

$$for 0 \leq n < N$$

where:

X=spectral coefficients

n=sample index

i=window index

k=spectral coefficient index

N=window length

p₀=(N/2+1)/2

with N=1920 or 2048 (for example).

The AAC-ELD synthesis filterbank output x_{i,n} can be represented by:

$${x}_{i , n} = - \frac{2}{N} {\sum }_{k = 0}^{\frac{N}{2} - 1} X [ i ] [ k ] cos ( \frac{2 π}{N} ( n + {n}_{0} ) ( k + \frac{1}{2} ) )$$

$$for 0 \leq n < 2 N$$

where:

X=spectral coefficients

n=sample index

i=window index

k=spectral coefficient index

N=window length

n₀=(−N/2+1)/2

with N=960 or 1024 (for example).

In the case of AAC-ELD synthesis filterbank, it can be shown that,

x_{i,n+N}=−x_{i,n} for 0≦n<N.

Consequently, for 0≦n<N, the filterbank output x_{i,n} can be represented as:

$$\begin{matrix}x ( n + N ) = - \frac{2}{N} {\sum }_{k = 0}^{\frac{N}{2} - 1} X ( k ) cos ( \frac{2 π}{N} ( n + N + {n}_{0} ) ( k + \frac{1}{2} ) ) ; \\ = \frac{2}{N} {\sum }_{k = 0}^{\frac{N}{2} - 1} X ( k ) cos ( \frac{2 π}{N} ( n + {n}_{0} ) ( k + \frac{1}{2} ) ) ; \\ = - x ( n ) .\end{matrix}$$

$$\begin{matrix}x ( n ) = - \frac{2}{N} {\sum }_{k = 0}^{\frac{N}{2} - 1} X ( k ) cos ( \frac{2 π}{N} ( n + {p}_{0} - \frac{N}{2} ) ( k + \frac{1}{2} ) ) ; \\ = - \frac{2}{N} {\sum }_{k = 0}^{\frac{N}{2} - 1} {( - 1 )}^{k} X ( k ) sin ( \frac{2 π}{N} ( n + {p}_{0} ) ( k + \frac{1}{2} ) ) ; \\ = - \frac{2}{N} {\sum }_{k = 0}^{\frac{N}{2} - 1} {( - 1 )}^{( \frac{N}{2} - 1 - k )} X ( \frac{N}{2} - 1 - k ) \\ sin ( \frac{2 π}{N} ( n + {p}_{0} ) ( \frac{N}{2} - 1 - k + \frac{1}{2} ) ) ; \\ = \frac{2}{N} {( - 1 )}^{( n + \frac{N}{4} + 1 )} {\sum }_{k = 0}^{\frac{N}{2} - 1} {( - 1 )}^{( \frac{N}{2} - 1 - k )} X ( \frac{N}{2} - 1 - k ) \\ cos ( \frac{2 π}{N} ( n + {p}_{0} ) ( k + \frac{1}{2} ) ) ;\end{matrix}$$

which allows reuse of core IMDCT filterbank for its implementation. Note that the right hand side of the Note that the right hand side of the summation is an IMDCT (e.g., as in Equation 4). The algorithm for the synthesis filterbank may include:
1. Invert the signs of the odd-indexed spectral coefficients X(k) if N/2 even, or invert the signs of the even-indexed spectral coefficients if N/2 is odd;
2. Reverse the order of the spectral coefficient sequence;
3. Apply the IMDCT transform to the to the spectral coefficients obtain output samples;
4. Invert the signs of the even-indexed output samples if N/4 is even; or invert the signs of odd-indexed output samples if N/4 is odd; these form the first N output points of the synthesis filterbank;
5. The remaining N output samples are obtained by inverting the signs of the first N samples.

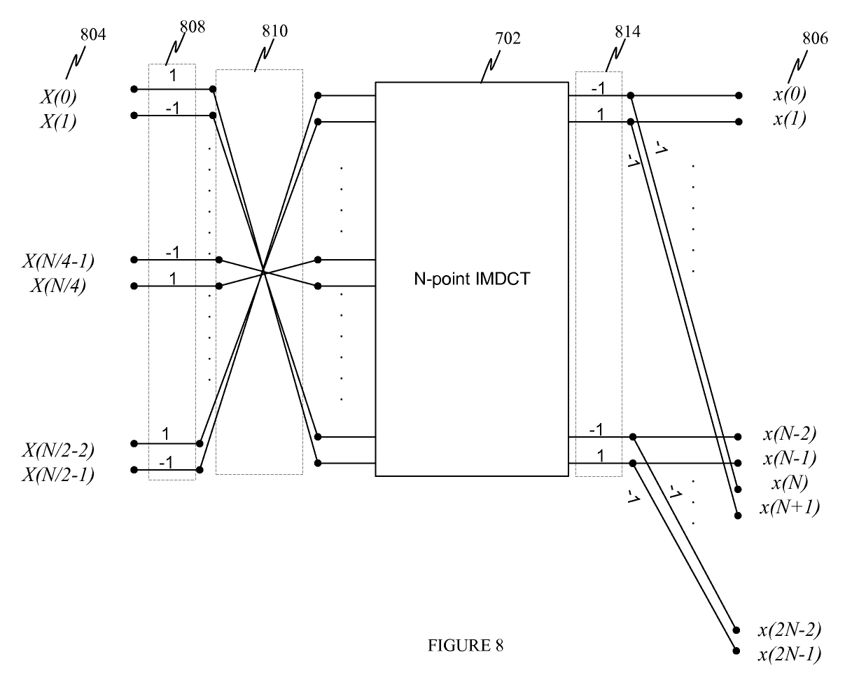

FIG. 8 is a diagram illustrating the operations that are performed to reuse the core IMDCT of FIG. 7 for an AAC-ELD algorithm. This figure assumes that N/4 is an even number. To obtain the analysis filterbank output 806 x(n) for 0≦n<N, input spectral coefficients X(0) to X(N/2−1) 804 are obtained. If N/4 is an even number, the signs of even-indexed input spectral coefficients are inverted 808 (otherwise, if N/4 is odd, the signs of odd-indexed input spectral coefficients are inverted). The order of the sign-inverted input spectral coefficients 804 is then reversed 810 and the IMDCT transform is applied 702 to obtain output samples. If N/2 is an even number, the signs of odd-indexed output samples are then inverted 814. Note that if N/2 is an odd number, the signs of even-indexed samples are inverted instead. These form the first N output samples of the synthesis filterbank. The remaining output samples can be obtained by inverting the signs of the first N output samples. Note that the functions and/or operations described in FIG. 8 may be performed in hardware, software, or a combination of the two.

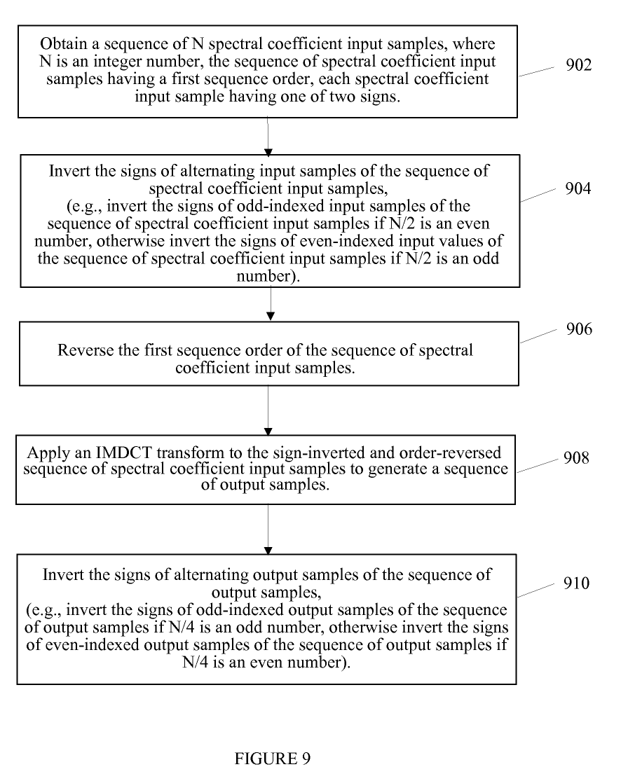

FIG. 9 illustrates a method of performing AAC-ELD algorithm using a core IMDCT for an AAC algorithm. A sequence of N spectral coefficient input samples is obtained 902, where N is an integer number, the sequence of spectral coefficient input samples having a first sequence order, each spectral coefficient input sample having one of two signs. The signs of alternating input samples of the sequence of spectral coefficient input samples are then inverted 904. For instance, the signs of odd-indexed input samples of spectral coefficients input samples are then inverted if N/2 is an even number, otherwise the signs of even-indexed input samples of of the sequence of spectral coefficients input samples are inverted if N/4 is an odd number. The first sequence order of the sequence of spectral coefficient input samples is reversed 906. An IMDCT transform is then applied to the sign-inverted and order-reversed sequence of spectral coefficient input samples to generate a sequence of output samples. 908. Finally, the signs of alternating output samples of the sequence of output samples are then inverted 910. For example, the signs of odd-indexed output samples of the sequence of output samples are inverted if N/4 is an odd number, otherwise the signs of even-indexed output samples of the sequence of output samples are inverted if N/4 is an even number.

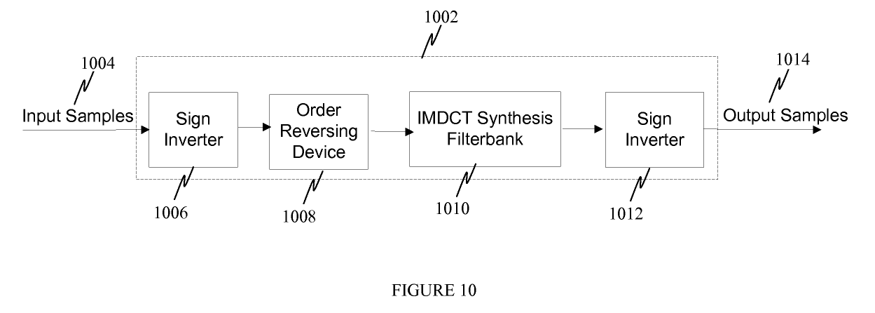

FIG. 10 is a block diagram illustrating a device, circuit, and/or processor adapted to reuse an AAC algorithm IMDCT for an AAC-ELD algorithm. The device, circuit, and/or processor 1002 may include a first Sign Inverter 1006 that obtains a sequence of spectral coefficient input samples 1004, the sequence of spectral coefficient input samples having a first sequence order, each spectral coefficient input sample having one of two signs. The first Sign Inverter 1006 may be further configured to invert the signs of input samples 1004. For instance, where the window length is N and if N/2 is an even number, the first Sign Inverter 1006 may invert the signs of odd-indexed input samples of a sequence of spectral coefficient input samples 1004. Alternatively, if N/2 is an odd number, the Sign Inverter 1006 may invert the signs of even-indexed input samples of the sequence of spectral coefficient input samples 1004. An Order Reversing Device 1008 then reverses the first sequence order of the sequence of spectral coefficient input samples (e.g., the sequence of the spectral coefficients is reversed). An IMDCT Synthesis Filterbank 1010 then applies an IMDCT transform to the sequence of spectral coefficient input samples to generate a sequence of output samples. Then, a second Sign Inverter 1012 inverts the signs of odd-indexed output samples of the sequence of output samples if N/4 is odd, or inverts the signs of even-indexed output samples of the sequence of output samples if N/4 is even, to provide the sign-inverted Output Samples 1014.

Consequently, both AAC and ELD-AAC filterbanks can be implemented by using the same N-point MDCT core transform or IMDCT core transform. Support for both types of filterbanks is possible by using only order-reversal and sign-inversion operations, with minimum impact on overall complexity of the implementation.

Information and signals may be represented using any of a variety of different technologies and techniques. For example, data, instructions, commands, information, signals and the like that may be referenced throughout the above description may be represented by voltages, currents, electromagnetic waves, magnetic fields or particles, optical fields or particles or any combination thereof.

The various illustrative logical blocks, modules and circuits and algorithm steps described herein may be implemented or performed as electronic hardware, software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. It is noted that the configurations may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

When implemented in hardware, various examples may employ a general purpose processor, a digital signal processor (DSP), an application specific integrated circuit (ASIC), a field programmable gate array signal (FPGA) or other programmable logic device, discrete gate or transistor logic, discrete hardware components or any combination thereof designed to perform the functions described herein. A general purpose processor may be a microprocessor, but in the alternative, the processor may be any conventional processor, controller, microcontroller or state machine. A processor may also be implemented as a combination of computing devices, e.g., a combination of a DSP and a microprocessor, a plurality of microprocessors, one or more microprocessors in conjunction with a DSP core or any other such configuration.

When implemented in software, various examples may employ firmware, middleware or microcode. The program code or code segments to perform the necessary tasks may be stored in a computer-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

As used in this application, the terms “component,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

In one or more examples herein, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. Software may comprise a single instruction, or many instructions, and may be distributed over several different code segments, among different programs and across multiple storage media. An exemplary storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is required for proper operation of the embodiment that is being described, the order and/or use of specific steps and/or actions may be modified without departing from the scope of the claims.

One or more of the components, steps, and/or functions illustrated in FIGS. 1, 2, 3, 4, 5, 6, 7, 8, 9 and/or 10 may be rearranged and/or combined into a single component, step, or function or embodied in several components, steps, or functions. Additional elements, components, steps, and/or functions may also be added. The apparatus, devices, and/or components illustrated in FIGS. 1, 2, 6 and 10 may be configured or adapted to perform one or more of the methods, features, or steps described in FIGS. 3-5 and 7-9. The algorithms described herein may be efficiently implemented in software and/or embedded hardware.

It should be noted that the foregoing configurations are merely examples and are not to be construed as limiting the claims. The description of the configurations is intended to be illustrative, and not to limit the scope of the claims. As such, the present teachings can be readily applied to other types of apparatuses and many alternatives, modifications, and variations will be apparent to those skilled in the art.

What is claimed is:

1. A method of providing an analysis filterbank, comprising:
obtaining a sequence of input samples, each input sample having one of two signs;
inverting the signs of alternating input samples of the sequence of input samples;
generating a sequence of spectral coefficient output samples by applying a modified discrete cosine transform (MDCT) to the sign-inverted sequence of input samples, the sequence of spectral coefficient output samples having a first sequence order, each spectral coefficient output sample having one of two signs;
reversing the first sequence order of the sequence of spectral coefficient output samples; and
inverting the signs of alternating output samples of the sequence of spectral coefficient output samples.

2. The method of claim 1, wherein the sequence of input samples is N samples long, and inverting the signs of alternating input samples of the sequence of input samples includes:
inverting the signs of even-indexed input samples of the sequence of input samples if N/4 is an even number; and
inverting the signs of odd-indexed input samples of the sequence of input samples if N/4 is an odd number.

3. The method of claim 1, wherein the sequence of input samples is N samples long, and inverting the signs of alternating output samples of the sequence of spectral coefficient output samples includes:
inverting the signs of odd-indexed output samples of the sequence of spectral coefficient output samples if N/2 is an even number; and
inverting the signs of even-indexed output samples of the sequence of spectral coefficient output samples if N/2 is an odd number.

4. The method of claim 1, wherein the MDCT is an advanced audio coding (AAC) filterbank.

5. The method of claim 4, wherein the analysis filterbank is an AAC enhanced low-delay (ELD) filterbank.

6. The method of claim 1, wherein the sequence of input samples is one of either 960 or 1024 samples long.

7. A device configured to provide an analysis filterbank, comprising:
a first sign inverter configured to obtain a sequence of input samples, each input sample having one of two signs, and invert the signs of alternating input samples of the sequence of input samples;
a filterbank module for generating a sequence of spectral coefficient output samples by applying a modified discrete cosine transform (MDCT) to the sign-inverted sequence of input samples, the sequence of spectral coefficient output samples having a first sequence order, each spectral coefficient output sample having one of two signs;
an order reversing device configured to reverse the first sequence order of the sequence of spectral coefficient output samples; and
a second sign inverter configured to invert the signs of alternating output samples of the sequence of spectral coefficient output samples.

8. The device of claim 7, wherein the sequence of input samples is N samples long, and the first sign inverter is configured to:
invert the signs of even-indexed input samples of the sequence of input samples if N/4 is an even number; and
invert the signs of odd-indexed input samples of the sequence of input samples if N/4 is an odd number.

9. The device of claim 7, wherein the sequence of input samples is N samples long, and the second sign inverter is configured to:
invert the signs of odd-indexed output samples of the sequence of spectral coefficient output samples if N/2 is an even number; and
invert the signs of even-indexed output samples of the sequence of spectral coefficient output samples if N/2 is an odd number.

10. The device of claim 7, wherein a first mode of operation for providing an advanced audio coding (AAC) filterbank, the sign inverters and reorder devices are inoperative and the
the filterbank module generate the sequence of spectral coefficient output samples by applying a modified discrete cosine transform (MDCT) to the sequence of input samples.

11. The device of claim 10, wherein a second mode of operation for providing an advanced audio coding (AAC) enhanced low-delay (ELD) filterbank, the sign inverters and reorder devices are operative.

12. A device configured to provide an analysis filterbank, comprising:
means for obtaining a sequence of input samples, each input sample having one of two signs;
means for inverting the signs of alternating input samples of the sequence of input samples;
means for generating a sequence of spectral coefficient output samples by applying a modified discrete cosine transform (MDCT) to the sign-inverted sequence of input samples, the sequence of spectral coefficient output samples having a first sequence order, each spectral coefficient output sample having one of two signs;
means for reversing the first sequence order of the sequence of spectral coefficient output samples; and
means for inverting the signs of alternating output samples of the sequence of spectral coefficient output samples.

13. The device of claim 12, wherein the MDCT is an advanced audio coding (AAC) filterbank.

14. The device of claim 13, wherein the analysis filterbank is an AAC enhanced low-delay (ELD) filterbank.

15. A circuit for providing an analysis filterbank, wherein the circuit adapted to:
obtain a sequence of input samples, each input sample having one of two signs;
invert the signs of alternating input samples of the sequence of input samples;
generate a sequence of spectral coefficient output samples by applying a modified discrete cosine transform (MDCT) to the sign-inverted sequence of input samples, the sequence of spectral coefficient output samples having a first sequence order, each spectral coefficient output sample having one of two signs;
reverse the first sequence order of the sequence of spectral coefficient output samples; and
invert the signs of alternating output samples of the sequence of spectral coefficient output samples.

16. The circuit of claim 15, wherein the MDCT is an advanced audio coding (AAC) filterbank.

17. The circuit of claim 16, wherein the analysis filterbank is an AAC enhanced low-delay (ELD) filterbank.

18. A machine-readable medium comprising instructions for providing an analysis filterbank, which when executed by one or more processors causes the one or more processors to:
obtain a sequence of input samples, each input sample having one of two signs;
invert the signs of alternating input samples of the sequence of input samples;
generate a sequence of spectral coefficient output samples by applying a modified discrete cosine transform (MDCT) to the sing-inverted sequence of input samples, the sequence of spectral coefficient output samples having a first sequence order, each spectral coefficient output sample having one of two signs;
reverse the first sequence order of the sequence of spectral coefficient output samples; and
invert the signs of alternating output samples of the sequence of spectral coefficient output samples.

19. The machine-readable medium of claim 18, wherein the MDCT is an advanced audio coding (AAC) filterbank and the analysis filterbank is an AAC enhanced low-delay (ELD) filterbank.

20. The method of providing a synthesis filterbank, comprising:
obtaining a sequence of spectral coefficient input samples, the sequence of spectral coefficient input samples having a first sequence order, each spectral coefficient input sample having one of two signs;
inverting the signs of alternating input samples of the sequence of spectral coefficient input samples;
reversing the first sequence order of the sequence of spectral coefficient input samples;
generating a sequence of output samples by applying an inverse modified discrete cosine transform (IMDCT) to the sign-inverted and order-reversed sequence of spectral coefficient input samples; and
inverting the signs of alternating output samples of the sequence of output samples.

21. The method of claim 20, wherein the sequence of spectral coefficient input samples is N samples long, and inverting the signs of alternating input samples includes:
inverting the signs of odd-indexed input samples of the sequence of spectral coefficient input samples if N/2 is an even number; and
inverting the signs of even-indexed input samples of the sequence of spectral coefficient input samples if N/2 is an odd number.

22. The method of claim 20, wherein the sequence of spectral coefficient input samples is N samples long, and inverting the signs of alternating output samples includes:
inverting the signs of odd-indexed output samples of the sequence of output samples if N/4 is an odd number; and
inverting the signs of even-indexed output samples of the sequence of output samples if N/4 is an even number.

23. The method of claim 20, wherein the IMDCT is an advanced audio coding (AAC) filterbank.

24. The method of claim 23, wherein the synthesis filterbank is an AAC enhanced low-delay (ELD) filterbank.

25. The method of claim 20, wherein the sequence of output samples is one of either 960 or 1024 samples long.

26. A device configured to provide a synthesis filterbank, comprising:
a first sign inverter configured to obtain a sequence of spectral coefficient input samples, the sequence of spectral coefficient input samples having a first sequence order, each spectral coefficient input sample having one of two signs, and the first sign inverter further configured to invert the signs of alternating input samples of the sequence of spectral coefficient input samples;
an order reversing device for reversing the first sequence order of the sequence of spectral coefficient input samples;
a filterbank module for generating a sequence of output samples by applying an inverse modified discrete cosine transform (IMDCT) to the sign-inverted and order-reversed sequence of spectral coefficient input samples; and
a second sign inverter configured to invert the signs of alternating output samples of the sequence of output samples.

27. The device of claim 26, wherein the sequence of spectral coefficient input samples is N samples long, and the first sign inverter is configured to:
invert the signs of odd-indexed input samples of the sequence of spectral coefficient input samples if N/2 is an even number; and
invert the signs of even-indexed input samples of the sequence of spectral coefficient input samples if N/2 is an odd number.

28. The device of claim 26, wherein the sequence of spectral coefficient input samples is N samples long, and the second sign inverter is configured to:
invert the signs of odd-indexed output samples of the sequence of output samples if N/4 is an odd number; and
invert the signs of even-indexed output samples of the sequence of output samples if N/4 is an even number.

29. The device of claim 26, wherein a first mode of operation for providing an advanced audio coding (AAC) filterbank, the first and second sign inverters and the order reversing device are inoperative and the filterbank module generates the sequence of output samples by applying a modified discrete cosine transform (MDCT) to the sequence of spectral coefficient input samples.

30. The device of claim 29, wherein a second mode of operation for providing an advanced audio coding (AAC) enhanced low-delay (ELD) filterbank, the sign inverters and reorder devices are operative.

31. A device configured to provide a synthesis filterbank, comprising:
means for obtaining a sequence of spectral coefficient input samples, the sequence of spectral coefficient input samples having a first sequence order, each spectral coefficient input sample having one of two signs;
means for inverting the signs of alternating input samples of the sequence of spectral coefficient input samples;
means for reversing the first sequence order of the sequence of spectral coefficient input samples;
means for generating output samples by applying an inverse modified discrete cosine transform (IMDCT) to the sign-inverted and order-reversed sequence of spectral coefficient input samples; and
means for inverting the signs of alternating output samples of the sequence of output samples.

32. The device of claim 31, wherein the IMDCT is an advanced audio coding (AAC) filterbank.

33. The device of claim 32, wherein the synthesis filterbank is an AAC enhanced low-delay (ELD) filterbank.

34. A circuit for providing a synthesis filterbank, wherein the circuit adapted to:
obtain a sequence of spectral coefficients input samples, the sequence of spectral coefficient input samples having a first sequence order, each spectral coefficient input sample having one of two signs;
invert the signs of alternating input samples of the sequence of spectral coefficient input samples;
reverse the first sequence order of the sequence of spectral coefficient input samples;
generate output samples by applying an inverse modified discrete cosine transform (IMDCT) to the sign-inverted and order-reversed sequence of spectral coefficient input samples; and
invert the signs of alternating output samples of the sequence of output samples.

35. The circuit of claim 34, wherein the MDCT is an advanced audio coding (AAC) filterbank.

36. The circuit of claim 35, wherein the analysis filterbank is an AAC enhanced low-delay (ELD) filterbank.

37. A machine-readable medium comprising instructions for providing an analysis filterbank, which when executed by one or more processors causes the one or more processors to:
obtain a sequence of spectral coefficients input samples, the sequence of spectral coefficient input samples having a first sequence order, each spectral coefficient input sample having one of two signs;
invert the signs of alternating input samples of the sequence of spectral coefficients input samples;
reverse the first sequence order of the sequence of input spectral coefficient input samples;
generate output samples by applying an inverse modified discrete cosine transform (IMDCT) to the sign-inverted and order-reversed sequence of spectral coefficient input samples; and
invert the signs of alternating output samples of the sequence of output samples.

38. The machine-readable medium of claim 37, wherein the MDCT is an advanced audio coding (AAC) filterbank.

39. The machine-readable medium of claim 38, wherein the analysis filterbank is an AAC enhanced low-delay (ELD) filterbank.
